(19) United States
(12) Patent Application Publication
(10) Pub. No.: US 2006/0249487 A1
(43) Pub. Date: Nov. 9, 2006

(54) Method and a device for laser spot welding

(75) Inventors: Paraskevas Dunias, Eindhoven (NL); Antonius Hermanus Maria Blom, Eindhoven (NL); Pieter Geert Van Engen, Eindhoven (NL); Carsten Heinks, Eindhoven (NL); Cornelis Josephus Gerardus Maria De Kok, Eindhoven (NL); Willem Hoving, Eindhoven (NL); Durandus Kornelius Dijken, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/539,322

(22) PCT Filed: Dec. 19, 2003
(86) PCT No.: PCT/IB03/06076

§ 371 Date: Jun. 15, 2005

(30) Foreign Application Priority Data
Dec. 20, 2002 (EP) 02080627.9

(51) Int. Cl. B23K 26/22; B23K 26/03

(52) U.S. Cl. 219/121.64; 219/121.62; 219/121.83

(57) ABSTRACT

A method for laser spot welding, whereby a laser beam is directed to the material to be welded, and whereby, during the welding operation, the surface temperature of said material at the spot of the weld is detected. The presence of a weld can be determined depending on the detected surface temperature after the laser beam is switched off. Furthermore, the power of the laser beam can be controlled depending on the detected surface temperature. To control the welding operation, also the reflected laser radiation from the spot of the weld can be detected.

The invention is related to a method and a device for laser spot welding, whereby a laser beam is directed to the material to be welded. Laser spot welding is a joining technology, using a laser beam to locally heat the material of the two parts to be connected. Thereby the laser beam is focussed onto a limited area of the surface of the material (hereinafter called the weld spot), whereby the power density of the laser beam is high, so that melting and fusion of the material of the two parts is realized in a short time. When the technique is used for making miniature welds on small products, it is called laser micro spot welding. Thereby the processing time is very short, for example in the order of 0.5-20 ms (milliseconds).

The combination of a small weld spot and a short process time leads to a limited heat effected area, which makes this technique a good candidate for joining small delicate parts which require well-controlled physical dimensions and/or geometrical stability, as well as for complicated constructions of different parts of plate material. Laser spot welding can be used for welding many kinds of metal and metal alloys, such as copper, many kinds of steel and stainless steel.

Effective control of the spot welding operation is possible in case the properties and the condition and dimensions of the parts to be welded are exactly known before the spot welding operation starts. In that case the weld can have a predetermined quality and dimension, provided that the control of the welding operation is adapted to said properties, condition and dimensions. However, in most cases the material properties and/or the condition and/or the dimensions of the parts to be joined are not exactly known. Then the quality of the weld varies and should be judged by examination afterwards.

An object of the invention is a spot welding operation by means of a laser beam, whereby the operation is monitored in such a way that the quality of the resulting spot weld is detected during the spot welding operation, and/or that said quality can be improved.

To accomplish that objective, the surface temperature of said material at the spot of the weld is detected during the welding operation. Thereby the welding operation comprises the period of time including the time that the laser beam is directed to the material to be welded and the time after the laser beam is switched off and the material is cooling down. To measure the surface temperature of the material in the limited area of the spot of the weld, the infrared emission from that limited area can be measured by, for example, an InGaAs photo diode, or an other infrared detection sensor.

The applied laser energy will diffuse through the material of the parts to be joined, resulting in a certain temperature gradient profile in the material. This profile is hardly accessible for measurements, but information about the heat distribution can be extracted by measuring its dynamic response (i.e. time dependent behavior) of the surface temperature. For example, the actual existence of metallic contact between the two parts to be joined can be detected. Verification tests have shown that the known InGaAs photo diode sensor can adequately detect the infrared emission from the surface of the spot of the weld.

Preferably, the laser beam, on its way to the weld spot, is reflected by means of a mirror, while infrared radiation coming from the weld spot passes through said mirror and is measured by a sensor to determine the surface temperature at the spot of the weld. The sensor can be located behind the mirror. Thereby the infrared emission to be measured by the sensor follows the same way as the laser beam, be it in the reverse direction. Thereby it is ensured that the measured infrared emission is only coming from the weld spot area.

In one preferred embodiment, the absence or the presence of a weld, in particular of a good weld, is determined depending on the detected surface temperature of the spot of the weld in the cooling down phase of the welding process. In this last phase of the welding operation the laser beam can be switched off, or the power of the laser beam is considerably decreased. Thereby the surface temperature of the material at the weld spot decreases, mainly because the heat will diffuse through the material. Such diffusion will take place more rapidly in case a good fusion of melted material of both parts has been created. Then the connecting weld between the two parts can serve as a heat conducting bridge, whereby the diffusion of the heat will take place through the material of both parts. So, a relatively rapid decrease of the surface temperature after switching off the laser beam leads to the conclusion that a correct weld is created, while a relatively slow decrease of the temperature leads to the conclusion that no weld, or no good weld, is created.

After the laser beam is switched on the surface temperature will increase due to the absorption of energy in the material. By measuring the surface temperature the moment of the solid-liquid phase change at the surface of the material can be detected, because the phase change temperature (melting temperature) of the material is a known parameter.

Therefore, in one preferred embodiment, the power of the laser beam is decreased when a predetermined surface temperature level is detected, the surface temperature level being the solid-liquid phase change temperature (melting temperature) or a temperature near that temperature, in particular just above the melting temperature. In particular when welding copper material, the absorption coefficient of the laser power in liquid material is much higher than in solid material. Therefore, the welding process can be kept stable by decreasing the power of the laser beam when the material starts to melt.

Preferably, the power of the laser beam is controlled depending on the detected surface temperature of the material at the spot of the weld. Such feed back control keeps for example the surface temperature during a certain period at a predetermined level by decreasing the laser power when the surface temperature increases above said predetermined level, and by increasing the laser power when the surface temperature decreases below said predetermined level. Also a desired set-point contour (variation of the set-point in the time) can be chosen, whereby the surface temperature follows said contour.

In one preferred embodiment, the feed back control of the power of the laser beam directed to the weld spot starts after the surface temperature has reached a predetermined level, which level is preferably a temperature near the melting temperature of the material to be welded. Thereby the melting phase of the laser spot welding operation can be controlled in an effective manner.

So, when measuring the surface temperature at the spot of the weld, the value and/or the variation of that temperature can be used for judging the quality of the weld, in particular the presence or the absence of a good weld, and/or for determining the moment that the material starts melting and/or for controlling the power of the laser beam by means of feed back control. All these three methods can be seen as separate inventions, because each of the three methods can be applied independent from the other two methods.

In one preferred embodiment, the reflected laser radiation from the spot of the weld is detected, in order to calculate the laser power that is absorbed by the material to be welded. From the power of the laser beam that hits the weld spot, only a part of that power is absorbed by the material to be welded, and the other part is reflected by the surface of the material at the weld spot.

In one preferred embodiment, the power of the laser beam is controlled depending on the laser power absorbed by the material to be welded, whereby the feed back control preferably starts after the surface temperature has reached a predetermined level, which level is preferably a temperature near the melting temperature of the material to be welded.

The absorbed laser power is an important parameter for controlling the power of the laser beam that hits the material to be welded. The absorbed laser power can be integrated over the time to calculate the laser energy that is absorbed by the material to be welded. Preferably, to calculate the absorbed laser power, the power of the reflected laser radiation should be determined in order to deduct it from the power of the laser beam that hits the surface of the material.

In one preferred embodiment, the power of the laser beam is switched off, or is decreased, after predetermined laser energy is absorbed by the material to be welded. It has appeared that a good quality weld can be obtained when the absorbed energy is kept on a constant value, which value can be easily determined by experimentation.

Preferably the reflected laser radiation is determined as follows. The reflected laser power radiates from the surface of the weld spot in different directions. A certain part (fraction) of the reflected laser radiation is caught by the optical system though with the laser beam is directed to the weld spot. The power of that certain part can be measured by a sensor, for example a germanium photo diode. The power of the sensed laser radiation is proportional to the reflected power, so that the total reflected laser radiation can be calculated by multiplying the sensed power by a certain factor that can be easily determined by experimentation.

The power of the laser beam that hits the weld spot can be calculated based on the data of the laser device, but it can also be calculated based on measurements in the optical system, as will be further explained later.

In one preferred embodiment, the laser beam, on its way to the weld spot, is reflected by means of a mirror and a part of the reflected laser radiation coming from the weld spot passes through said mirror and is measured by a sensor.

The feed back control of the power of the laser beam that hits the material to be welded, depending on the absorbed laser power, can be seen as a separate invention, because it can also be applied independent from the other methods described in this description.

The invention is furthermore related to a device for laser spot welding, comprising means for directing a laser beam to the material to be welded, characterized in that temperature detections means are present for detecting, during the welding operation, the surface temperature of said material at the spot of the weld. Preferably, control means are present for controlling the power of the laser beam depending on the detected surface temperature.

Preferably, means for calculating the laser energy absorbed by the material to be welded are present, and control means are present for controlling the power of the laser beam depending on the absorbed laser energy.

The invention will now be further explained, whereby reference is made to the drawing comprising figures, in which:

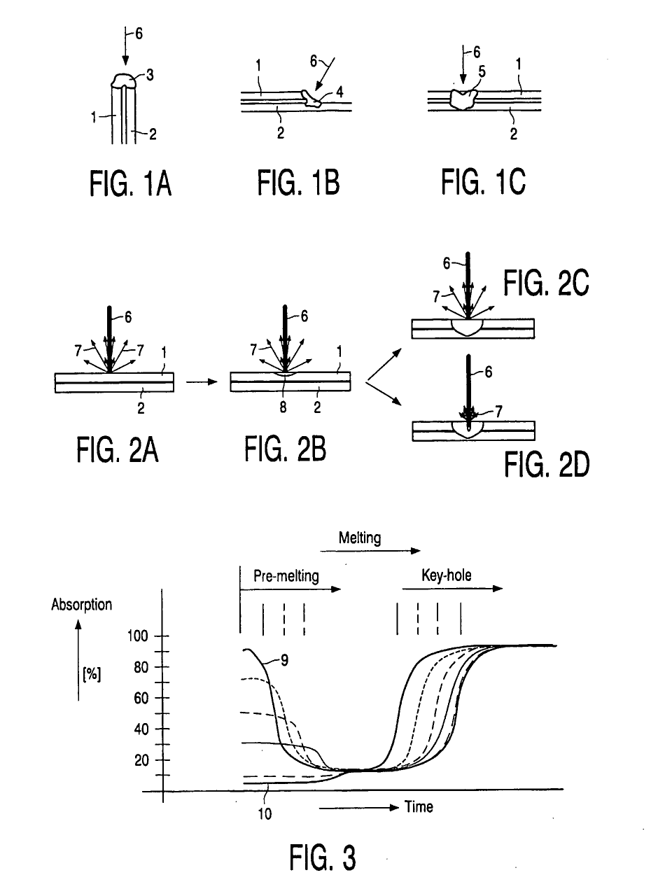

FIG. 1A-C show different laser spot welding geometries;

FIG. 2A-D show different phases of a spot welding operation;

FIG. 3 shows the absorption of laser power over the time;

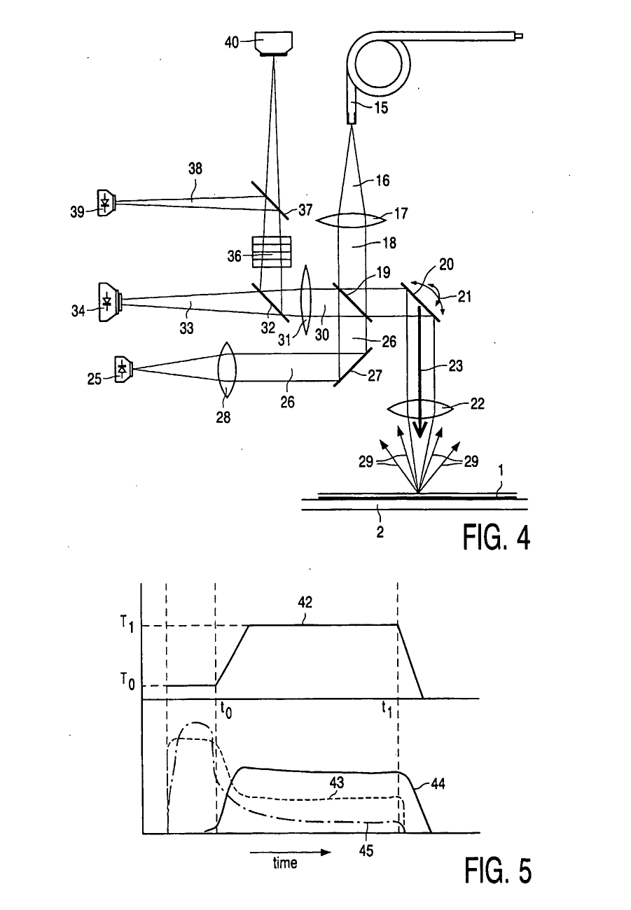

FIG. 4 shows an example of a laser spot welding set-up with different sensors, and

FIG. 5 shows a control strategy for laser spot welding;

Laser spot welding is a joining technology, which can be used for the connection of many kinds of material in many shapes, especially for plate like metal materials. For example, it can be used for miniature welds on small products. The typical characteristic of this joining technology is that the laser beam remains focussed on the same spot during the processing operation of the laser beam. In case of micro spot welding such processing operation time is short, for example 0.5-20 ms (milliseconds). Several different welding types are used in industry, among which the standing edge weld, the overlap fillet weld and the overlap penetration weld are the most important types.

FIGS. 1A, 1B and 1C show these laser spot welding geometries. Plate 1 is connected to plate 2 by a spot weld 3,4,5. The two plates 1,2 are presented in FIG. 1 at some mutual distance, however, in practice they may touch each other, whereby often dirt or other material is enclosed between the two plates 1,2. Because the plates are mostly not completely flat, there is often un unknown small gap between the surfaces of abutting the plates 1,2. FIG. 1A shows a ‘standing edge’ spot weld 3 connecting the two edges of the plates 1,2. FIG. 1B shows an ‘overlap fillet’ spot weld 4, whereby the weld 4 connects the edge of plate 1 to the surface of plate 2. FIG. 1C shows an ‘overlap penetration’ weld 5, whereby the surfaces of the two plates 1,2 are connected through the weld 5. Arrow 6 represents the direction of the laser beam in FIGS. 1A, 1B and 1C.

The overlap penetration weld is the most critical geometry because the distribution of the laser energy over the work piece is heavily influenced by the interface between the two metal parts. FIGS. 2A, 2B, 2C and 2D show different phases of the spot welding process for the overlap penetration geometry. The figures show two metal plates 1,2, whereby arrow 6 represents the laser beam 6 that hits the upper plate 1 perpendicularly. The laser beam reflection and the infrared radiation are indicated with arrows 7.

FIG. 2A shows the pre-melting phase, whereby for many materials the absorption of the laser power (energy) increases with the increase of the temperature, so that the process more or less accelerates during heating. FIG. 2B shows the melting phase, whereby the material of plate 1 within the spot area is initially partly solid and partly liquid, while becoming complete liquid at the end of the melting phase. The liquid material is indicated with numeral 8. FIG. 2C shows the accomplished heat conduction weld. There is hardly any vaporization and the surface of plate 1 is more or less undistorted and flat. In case of a more powerful laser beam the situation as presented in FIG. 2D will occur, the so called key-hole spot welding, whereby the recoil pressure of the vaporized material pushes the liquid aside, caching the laser beam.

During the spot welding process, the absorption coefficient changes, but also other parameters may change, such as the heat conductivity, which depend on the temperature of the material and the phase (solid or liquid) of the material. Moreover, depending on the material to be welded and the condition of that material, the initial absorption coefficient can vary. For example in case of copper, the absorption of the laser beam increases slowly during heating up of the surface of the material, but at the moment that the melting starts, the absorption coefficient almost doubles. Therefore, reducing the laser power immediately at the moment of melting is important to keep the process in a stable operation. This moment is however depending on the amount of power absorption during the initial phase and even a 10% variation (which can be expected from normal oxidation) can be sufficient to cause stability problems. Problems can be made much smaller by improving and securing the absorption of the ‘initial’ material by means of a pre-treatment like oxidizing, etching, sandblasting or coating. The effects of the pre-treatment will disappear as soon as the melting phase starts. When the process goes into the key-hole situation, another change in absorption will start, taking the laser absorption up to almost 100% in case of deep key-hole processing.

Introducing a pre-treatment to the material will give a better defined absorption during the pre-melting phase. Once molten, the disturbing effects of other process parameters like the distance between the parts to be welded are still influencing the process. Real-time feed back techniques can handle absorption variations as well as other process parameter variations like gap (distance between the parts) variation, affecting weld dynamics, for example the heat diffusion through the structure.

FIG. 3 shows the absorption variation of a spot welding process of copper parts during the sequential phases. The figure indicates the effect of the initial absorption of the laser energy on the process which follows. The figure shows that in case of a high absorption in the pre-melting phase, the melting phase as well as the key-hole phase will start relatively early (continuous line 9). Such high absorption will occur when the surface of the material is made black. When the surface is polished there is a low initial absorption as is shown by the continuous line 10. In that case the melting phase and the key-hole phase start much later. The lines between the two continuous lines 9,10 represent different initial absorptions between 10% and 80%. So, the exact moments of the critical phase changes vary and this is where the feed back control technique may help to adjust the laser source output to the evolving process.

FIG. 4 shows an example of a laser spot welding set-up with different sensors for monitoring the welding operation aiming at an effective process control, in particular a feed back control. FIG. 4 represents the set-up only schematically, and further lenses, filters and diaphragms are not shown, but may be applied.

Two metal plates 1,2 have to be spot welded against each other with an overlap penetration weld. The laser beam is arriving through a 400 micron glass fibre 15. The diverging laser beam 16 coming from the glass fibre 15 is passing lens 17 to obtain a parallel laser beam 18. First mirror 19 directs the laser beam 18 towards moveable mirror 20. Mirror 20 can rotate a little around two axes as is indicated by arrows 21, so that the laser beam (represented by arrow 23) can be directed exactly to the desired location at the surface of metal plate 1. Before the laser beam 23 hits the surface of plate 1, it passes a lens 22, so that the laser beam 23 is converging to be concentrated on the weld spot.

First mirror 19 reflects the major part of the laser beam 18, however, a predetermined fraction of the laser beam 18 is not reflected by mirror 19, but passes mirror 19. Such mirrors are known per se. The power (energy) of the laser beam 26 that passes mirror 19 is detected by means of sensor 25, after it is reflected by mirror 27 and has passed lens 28 to obtain a converging laser beam directed towards sensor 25. Sensor 25 is a germanium photo diode. The power of the laser beam 26 is proportional to the power of laser beam 23, so that the power of the laser beam 23 that hits the weld spot can easily be calculated after the power of laser beam 26 is measured by means of sensor 25.

A part of the power of the laser beam 23 is absorbed by the material of plate 1, so that the material is heated up locally at the spot where the laser beam 23 hits the plate 1. However, the other part of the laser beam is reflected by the surface of plate 1 and radiates away from that surface as is indicated by arrows 29. In order to calculate the power of the laser beam 23 that is absorbed by plate 1, the power of the reflected laser radiation is detected as follows.

A certain fraction of the reflected laser radiation (arrows 29) is directed to lens 22. That reflected laser radiation forms a laser beam after it has passed lens 22, which laser beam follows the same route as laser beam 23, be it in reverse direction. After it is reflected by mirror 21 it reaches mirror 19. As said before, a part (a certain fraction) of the laser beam passes mirror 19. That fraction forms laser beam 30. To create a converging beam, laser beam 30 passes lens 31, and the converging beam is directed towards mirror 32. A certain fraction of the laser beam 30 passes mirror 32, just as is the case with mirror 19, so that the power of the laser beam 33, that reaches sensor 34, is proportional to the power of the laser radiation that is reflected by the surface of plate 1. Therefore, the power of the reflected laser radiation 29 can be easily calculated after the power of laser beam 33 is measured by sensor 34. Sensor 34 is also a germanium photo diode.

The difference between the energy of laser beam 23 and the energy of the laser radiation 29 is the energy that is absorbed by the plate 1. So, the absorbed energy at any moment can be calculated by continuously detecting the power of laser beam 23 and the power of the reflected laser radiation 29, and by calculating the energy of both.

The calculation of the absorbed energy by the surface of plate 1 can not be done with extreme high accuracy. The practical set-up does not permit the detection of all reflected laser power. As shown in FIG. 4, only the reflected power which returns into the aperture of the optical system is measured. However, a reasonable estimate of the part (fraction) of the reflected laser radiation that reaches the optical system can be made after some practical experiments. At the other hand, the input laser power is detected reliably with the sensor 25 behind the first mirror 19, detecting a known and fixed fraction of the incoming laser power, passing the mirror 19.

The absorbed laser energy will diffuse through the parts to be welded, resulting in a certain temperature gradient profile in said parts. This profile is hardly accessible by on-line measurements, but information about the heat distribution can be extracted by looking at the dynamic behavior of the temperature at the surface of the material at the spot of the weld. Notably, the actual existence of good metallic contact between the two metal plates 1,2 can be detected.

In order to measure the surface temperature at the weld spot, a part of the infrared radiation from that surface, also indicated with arrows 29, is caught by said aperture of the optical system, so that it passes lens 22 and is reflected by mirror 20 towards first mirror 19. A certain part of the infrared radiation passes mirror 19 and lens 31, and is reflected by mirror 32. Then it will pass a so called Nd:YAG filter 36, which filter blocks the laser radiation. Mirror 37 will direct enough infrared radiation 38 towards sensor 39, to enable sensor 39 to measure the surface temperature of the weld spot. Sensor 39 is a so called InGaAs photo diode.

In the set-up according to FIG. 4, the spot of the weld is observed by a CCD camera 40. Thereby visible light from the spot of the weld, which is detected by the CCD camera, follows the same route through the optical system as the reflected laser radiation, be it that the light passes mirror 37 on its way to CCD camera 40.

In the embodiment according to the described set-up, all sensors 25,34,39 have local preamplifiers and the amplified signals are fed to a filter unit. This filter unit performs straight forward anti-aliasing filtering for all sensor signals. Besides that, the signals from the optical sensors are processed with a comb filter which suppresses the fundamental frequency and all higher harmonics of the switched mode power supply current to the flash lamps of the laser unit. The laser power modulation due to the chopper frequency is thus completely suppressed in the sensor signals and will not disturb the control loop. Hard-ware filtering is selected for this application as it is expected that the full processing performance of the controller is needed for the control action as such.

The controller hardware in the example is the DAP5200a signal acquisition processor board from Microstar Laboratories. This board provides eight analogue input channels with two AD converters with 14 bit resolution and a sampling frequency up to 400 kHz (50 kHz per channel in case all are used). Two analogue output channels are provided to drive actuators. In the embodiment only one is used for the power set-point to the laser unit. The processing of the input data, and generation of the output signal, runs on the onboard processor.

FIG. 5 shows a control strategy for laser spot welding of copper plates, whereby the time is represented at the horizontal axis. Line 42 represents the desired surface temperature at the spot of the weld. During the pre-melting phase, up to moment to, the desired temperature is T₀, being the temperature whereby the copper material starts melting. The material has to be heated from room temperature to a temperature just above melting temperature, without the process getting unstable due to the solid-liquid phase change difficulties as described before. This is achieved over the pre-melting phase up to moment t₀. As soon as the measured temperature exceeds the pre-set threshold value T₀, the pre-melting phase is accomplished and the melting phase is started. In this phase the laser power is controlled such that the measured surface temperature follows line 42, whereby a PI controller takes the temperature from temperature T₀ up to the desired fusion temperature T₁, and keeps it there for some time (the horizontal part of line 42) up to the moment t₁, being the moment that a predetermined laser energy is absorbed by the material of the plates 1,2. Moment t₁ is the end of the melting phase. At moment t₁ the power of the laser beam is decreased or even switched off, so that the temperature of the weld is going down to room temperature, according to the last part of line 42. For copper, this cooling curve is not very critical.

The lower part of FIG. 5 shows the power of the laser beam (dotted line 43), being controlled depending from the desired surface temperature (line 42). Furthermore the actual surface temperature of the weld spot (line 44) and the reflected laser radiation (line 45) is represented.

The welding process has a direct relation to the thermal changes of the material to be welded and the phase (solid or liquid) of the material. The welding process changes drastically when the material passes from the solid phase to the liquid phase where the fusion of the material takes places. Therefore different process phases have been defined where on the one hand a different model has to be determined and on the other hand a different controller. As said before, the following phases of the process can be defined.

In the pre-melting phase, the laser power can be kept constant until the material starts melting (only a P-regulation is active). Next, in the melting phase, the real controlling scheme is used to regulate the process according to the melt surface temperature (in this phase a PID regulator is used). Finally, the melting phase is terminated at a certain moment (t₁), where the cooling down starts. The different phases will be described in more detail hereinafter.

The pre-melting phase involves the heating of the material till the melting phase starts. That moment t₀ (see FIG. 5) is determined from the detected surface temperature at the spot of the weld. That moment can also be determined from a change of the reflected laser light signal, depending on the material to be welded.

The melting phase is an important phase, because during this phase the factual welding takes place. The aim during this phase can be to keep the temperature constant till the moment the melt has reached a sufficient penetration depth. In general, the length of this phase determines the quality and reproducibility of the weld. Therefore, a smart regulation can be implemented to adaptively control the length of this phase.

During this phase the laser energy absorbed by the material is monitored. Thereby the length of the melting process can be controlled in such a way that the absorbed energy is kept constant. The absorbed energy is calculated by the integration of the absorbed laser power, which is the difference between the power of the laser beam that hits the material and the power of the reflected laser radiation, which are both measured, i.e. calculated based on measured values, as described above.

In the post-melting phase the laser spot welding operation is terminated with a certain cooling trajectory. For copper material the cooling trajectory is not so important for the quality of the joint (the weld). However, for other applications the cooling temperature trajectory can be of major importance for the quality of the welding operation.

Verification tests have been performed to compare the state of the art laser spot welding using a certain fixed pulse shape, with the new feed back controlled spot welding technique. The tests have been done on clean copper plates as well as on copper plates which were dirty. Spacers of 20, 40 and 60 micron thick have been used between the plates to create a corresponding gap between the plates. 100 micron thick copper plates were welded on 50 micron thick copper plates. The experiments showed that the actual size of the gap did not introduce much differentiation in the welding results of the new feed back controlled spot welding operation.

Table 1 shows the ‘clean’ version of the experiments and table 2 shows the results of similar experiments for dirty plates. The third column presents the spread in weld diameter measured at the bottom of the joined plates. This figure is a good measure for the reproducibility of the welding process. The fourth column simply gives the percentage of bad (or failing) welds.

TABLE 1
Verification tests on clean copper plates of 100 onto 50 micron

| Gap | | Good Welds | Bad welds |
|---|---|---|---|
| [μm] | Strategy | Spread D1(σ) [%] | Number [%] |
| 0 | Pulse shape | 8 | 0 |
| 0-60 | Pulse shape | 24 | 28 |
| 0 | Controlled | 3 | 0 |
| 0-60 | Controlled | 4 | 0 |

TABLE 2
Verification tests on dirty copper plates of 100 onto 50 micron

| Gap | | Good Welds | Bad welds |
|---|---|---|---|
| (μm) | Strategy | Spread D1(σ) % | Number % |
| 0 | Pulse shape | 41 | 7 |
| 0-60 | Pulse shape | 38 | 47 |
| 0 | Controlled | 7 | 0 |
| 0-60 | Controlled | 8 | 5 |

Table 1 shows that the open loop operating process performs well in case there is no gap between the parts. The disturbing effect of the gap (change of heat distribution through the plates) is effectively handled by the feed back controlled process. A similar effect can be seen in case dirty copper is used, introducing an additional disturbance. A significant improvement of the joining technique is achieved using the feed back controlled process.

The above described methods can equally well be applied to materials other than copper, especially to materials which are relatively highly reflective and/or relatively highly heat-conductive.

The decay behavior of the temperature of the surface of the material in the weld spot just after the leaser beam is switched off shows two clearly distinctive types of curves representing the presence or the absence of a good weld. Monitoring the quality of the weld can be done by measuring the signal level in the cooling down phase, whereby the power of the laser beam substantially decreased or switched off.

Besides the differentiation between good welds and weld failures, the technique can also be used to monitor the evolving spot welding process. It can detect when the effective physical contact between the parts to be joined is established (change of heat transfer characteristics) and therefore the process conditions can be corrected during the process for optimum result, thus for example compensating for gap effects between the parts.

Above only some examples of the method for laser spot welding are described; a great many other embodiments of the method are possible.

1. A method for laser spot welding, whereby a laser beam is directed to the material to be welded, characterized in that, during the welding operation, the surface temperature of said material at the spot of the weld is detected.

2. A method as claimed in claim 1, characterized in that the laser beam, on its way to the weld spot, is reflected by means of a mirror and that infrared radiation coming from the weld spot passes through said mirror and is measured by a sensor.

3. A method as claimed in claim 1, characterized in that the presence of a weld is determined depending on the detected surface temperature of the spot of the weld in the cooling down phase of the welding process.

4. A method as claimed in claim 1, characterized in that the power of the laser beam is controlled depending on the detected surface temperature of the material at the spot of the weld.

5. A method as claimed in claim 4, characterized in that the power of the laser beam is decreased when a predetermined surface temperature level is detected.

6. A method as claimed in claim 1, characterized in that the power of the laser beam is controlled depending on the laser power absorbed by the material to be welded.

7. A method as claimed in claim 6, characterized in that the laser power absorbed by the material is calculated by deducting the power of the reflected laser radiation from the power of the laser beam that hits the surface of the material.

8. A method as claimed in claim 6, characterized in that the power of the laser beam is switched off, or is decreased, after predetermined laser energy is absorbed by the material to be welded.

9. A method as claimed in claim 1, characterized in that a feed back control of the power of the laser beam directed to the weld spot starts after the surface temperature has reached a predetermined level, which level is preferably a temperature near the melting temperature.

10. A device for laser spot welding, comprising means for directing a laser beam to the material to be welded, characterized in that temperature detection means are present for detecting, during the welding operation, the surface temperature of said material at the spot of the weld.

11. A device as claimed in claim 10, characterized by means for calculating the laser energy absorbed by the material to be welded, and by control means for controlling the power of the laser beam depending on the absorbed laser energy.
